(19) United States
(12) Patent Application Publication
(10) Pub. No.: US 2008/0034670 A1
(43) Pub. Date: Feb. 14, 2008

(54) CHEMICALLY MODIFIED CHEMICAL MECHANICAL POLISHING PAD

(75) Inventors: Yuzhuo Li, Norwood, NY (US); Stuart D. Hellring, Pittsburgh, PA (US); Jason Keleher, Aurora, IL (US); Tianxi Zhang, Pullman, WA (US)

Correspondence Address: Deborah M. Altman;PPG Industries, Inc., Law Department - Intellectual Property, One PPG Place - 39th Floor, Pittsburgh, PA, 15272-0001, US

(73) Assignee: PPG INDUSTRIES OHIO, INC., Cleveland, OH (US)

(21) Appl. No.: 11/841,213

(22) Filed: Aug. 20, 2007

Related U.S. Application Data
(62) Division of application No. 11/202,470, filed on Aug. 12, 2005.

(51) Int. Cl. C09K 3/14

(52) U.S. Cl. 51/298

(57) ABSTRACT

A method of CMP of a substrate surface includes providing a polishing pad having a polishing layer, that may be substantially free of abrasive particles, with a functional group chemically bonded (covalent or ionic) to the polishing layer. The functional group acts as an activator or catalyst for a compound of a polishing slurry to exhibit a higher material removal rate for removing selected portions of the surface of the substrate than exhibited in CMP of a substantially identical substrate in the presence of a substantially identical polishing slurry and a polishing pad wherein the substantially identical polishing layer does not have the functional group. The functional group may be derived from a compound comprising a polyamine, a polyelectrolyte, and/or an amino acid. A method of making the CMP pad and the CMP pad formed thereby is also disclosed.

### CROSS-REFERENCE TO RELATED APPLICATIONS

This application is a division of U.S. patent application Ser. No. 11/202,470 filed Aug. 12, 2005.

### BACKGROUND OF THE INVENTION

1. Field of the Invention

The present invention relates to chemical mechanical polishing (CMP) for fabrication of advanced semiconductor devices. More particularly the present invention is directed to a chemically modified CMP pad, a process of making a chemically modified CMP pad, and a method of chemical mechanical polishing of advanced semiconductor devices.

2. Background Information

Chemical mechanical polishing (CMP) has become an enabling technology in fabricating advanced semiconductor devices, such as semiconductor wafers. In a commonly practiced chemical mechanical polishing (CMP) process, a rotating wafer holder brings the wafer to be in contact with a polishing pad or CMP pad. One of the key consumables in conventional CMP processes is the CMP pad or polishing pad. The CMP pad is mounted on a rotating platen. A polishing medium, such as an abrasive slurry, is applied between the wafer and the pad. An abrasive slurry for metal CMP generally contains an oxidizer, abrasive particles, a complexing agent, and a passivating agent. Abrasive free CMP processes are also known. In an abrasive free system, the abrasive particles are removed from the polishing medium.

An ideal CMP pad is flat and has a balanced hardness and compressibility to minimize dishing, erosion, and other defects. Commercially available polishing pads typically form the polishing layer of uniform polyurethane. In one manufacturing scheme for existing polyurethane CMP pads, a reactive composition is placed in a mold. After curing the composition to form polyurethane, the pad material is cut into slices used as the polishing layer of CMP pads. In another manufacturing approach, polyurethane beads are prepared first. The beads are then glued together with proper materials and additives during the casting. Existing CMP pads may also have one or more backing layers behind the polishing layer, such as a barrier layer that prevents passage of the slurry beyond the polishing layer or a soft backing layer to improve contact area of the polishing layer. Another type of existing CMP pad has fixed or dispersible abrasive particles in the polishing layer, which generally requires a binding material to hold (permanently or in a fashion which releases in use) the abrasive particles.

It is a goal of CMP pads to have a high material removal rate (MRR) while still maintaining sufficient planarizing characteristics. It would be advantageous if CMP pads could maximize their material removal rates at selected portions of the substrate being polished, namely raised portions thereof, to provide for an increased step height reduction efficiency for patterned wafer.

It is the object of the present invention to address at least some of these CMP pad design criteria in an efficient cost effective manner.

### SUMMARY OF THE INVENTION

It is noted that, as used in this specification and the appended claims, the singular forms “a,” “an,” and “the” include plural referents unless expressly and unequivocally limited to one referent.

For the purposes of this specification, unless otherwise indicated, all numbers expressing quantities of ingredients, reaction conditions, and other parameters used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

All numerical ranges herein include all numerical values and ranges of all numerical values within the recited numerical ranges. Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

The various embodiments and examples of the present invention as presented herein are understood to be illustrative of the present invention and not restrictive thereof and are non-limiting with respect to the scope of the invention.

According to one aspect of the present invention addressing at least one of the above stated objects a method of chemical mechanical polishing of a surface of a substrate to remove selected portions thereof includes providing a polishing pad having a polishing layer which is substantially free of abrasive particles and having a functional group chemically bonded to the polishing layer, and a polishing slurry in contact with at least a portion of the polishing layer of the polishing pad and in contact with at least a portion of the surface of the substrate. The method includes maintaining at least a portion of the surface of the substrate in sliding frictional contact with at least a portion of the polishing layer of the substrate in the presence of the polishing slurry until the selected portions of the surface of the substrate are removed. The functional group acts as an activator or catalyst for a compound of the polishing slurry to exhibit a higher material removal rate for removing selected portions of the surface of the substrate than exhibited in chemical mechanical polishing of a substantially identical substrate in the presence of a substantially identical polishing slurry and a polishing pad wherein the substantially identical polishing layer does not have the functional group.

In a non-limiting embodiment of the method of chemical mechanical polishing of the present invention the functional group is derived from a compound comprising a polyamine, a polyelectrolyte, and/or an amino acid.

According to one aspect of the present invention addressing at least one of the above stated objects, the present invention includes a chemical mechanical polishing pad for polishing a surface of a substrate to remove selected portions thereof, with the pad having a polishing layer configured to contact the surface of a substrate in the presence of a polishing slurry to remove selected portions thereof, and a polyamine chemically bonded to the polishing layer.

According to one aspect of the present invention addressing at least one of the above stated objects, the present invention includes a chemical mechanical polishing pad and slurry for polishing a surface of a substrate to remove selected portions thereof. The polishing slurry being configured to contact at least a portion of the pad and to contact at least a portion of the surface of the substrate during polishing. The pad includes a polishing layer of the pad configured to contact the surface of a substrate in the presence of the polishing slurry to remove selected portions thereof, wherein the polishing layer of the pad is substantially free of abrasive particles, and a functional group chemically bonded to the polishing layer of the pad wherein the functional group acts as an activator or catalyst for a compound in the polishing slurry to exhibit a higher material removal rate for removing selected portions of the surface of the substrate than exhibited in chemical mechanical polishing of a substantially identical substrate in the presence of a substantially identical polishing slurry and a polishing pad wherein the substantially identical polishing layer does not have the functional group.

According to one aspect of the present invention addressing at least one of the above stated objects, the present invention includes a method of modifying a chemical mechanical polishing pad adapted for polishing a surface of a substrate in the presence of a polishing slurry to remove selected portions thereof, wherein the pad has a polishing layer configured to contact the surface of the substrate in the presence of the polishing slurry to remove selected portions thereof. The method includes contacting the polishing layer with a solution containing a compound having a functional group for a period of time sufficient for the compound to chemically bond with the polishing layer, wherein the functional group acts as an activator or catalyst for a compound in the polishing slurry to exhibit a higher material removal rate for removing selected portions of the surface of the substrate than exhibited in chemical mechanical polishing of a substantially identical substrate in the presence of a substantially identical polishing slurry and a polishing pad wherein the substantially identical polishing layer does not have the functional group. Another aspect of the present invention includes the product made by this method.

The present invention will be further clarified in the description of the preferred embodiments taken together with the attached figures in which like reference numerals represent like elements throughout.

### BRIEF DESCRIPTION OF THE DRAWINGS

FIG. 1 is a schematic view of a chemical mechanical polishing process;

FIG. 2 is a schematic side sectional view of a chemical mechanical polishing pad according to the present invention for use in the process of FIG. 1;

FIGS. 3a and b are schematic views of a chemical mechanical polishing process with a chemical mechanical polishing pad according to one aspect of the present invention;

FIG. 4 is an IR spectrum graph of an existing chemical mechanical polishing pad;

FIG. 5 is an IR spectrum graph of the chemical mechanical polishing pad of FIG. 4 following a first processing step according to one aspect of the present invention;

FIG. 6 is an IR spectrum graph of a chemical mechanical polishing pad according to one aspect of the present invention;

FIG. 7 is an IR spectrum graph of a chemical mechanical polishing pad according to another aspect of the present invention;

FIG. 8 is an IR spectrum graph of another existing chemical mechanical polishing pad;

FIG. 9 is an IR spectrum graph of the chemical mechanical polishing pad of FIG. 8 following a first processing step according to one aspect of the present invention;

FIG. 10 is an IR spectrum graph of a chemical mechanical polishing pad according to another aspect of the present invention;

FIG. 11 is an IR spectrum graph of a chemical mechanical polishing pad according to another aspect of the present invention;

FIG. 12 is a comparative graph of the step height reduction relative to polishing times of the existing CMP pad represented in FIG. 4 and a CMP pad according to the present invention represented in FIG. 6; and

FIGS. 13a-c are schematic views of a chemical mechanical polishing process with a chemical mechanical polishing pad according to another aspect of the present invention.

### DESCRIPTION OF THE PREFERRED EMBODIMENTS

The present invention chemically modifies the surface of the polishing layer of the CMP pad to give the CMP pad an added functionality, whereby with such an added functionality, a CMP process, in particular a metal CMP process, can be vastly simplified. The polishing may be accomplished by supplying a solution of oxidizer between the CMP pad according to the present invention and the metal film to be polished. The oxidizer may be activated only at the sites that the CMP pad polishing layer surface according to the present invention, the oxidizer solution, and the metal film to be polished meet. A higher material removal rate is obtained at such sites. The removal rate would remain lower at the other sites on the wafer that do not have the same intimate contact with the CMP pad. This differential removal of the materials according to topography leads to an increased step height reduction efficiency for patterned wafer.

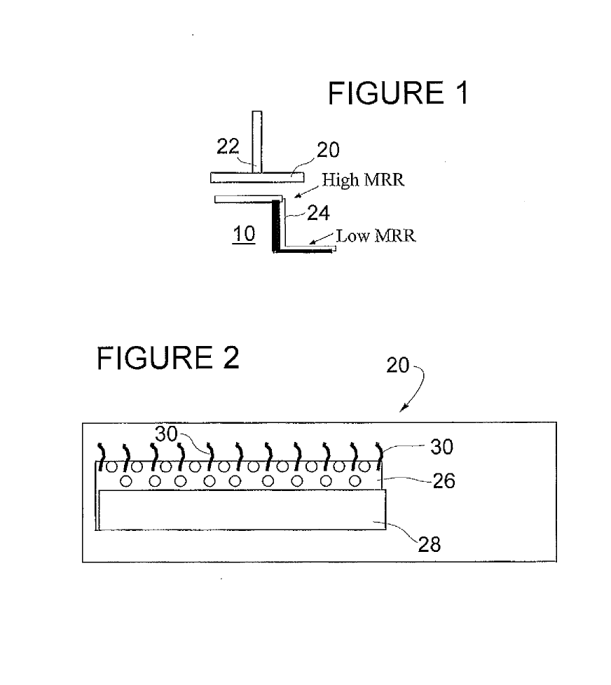

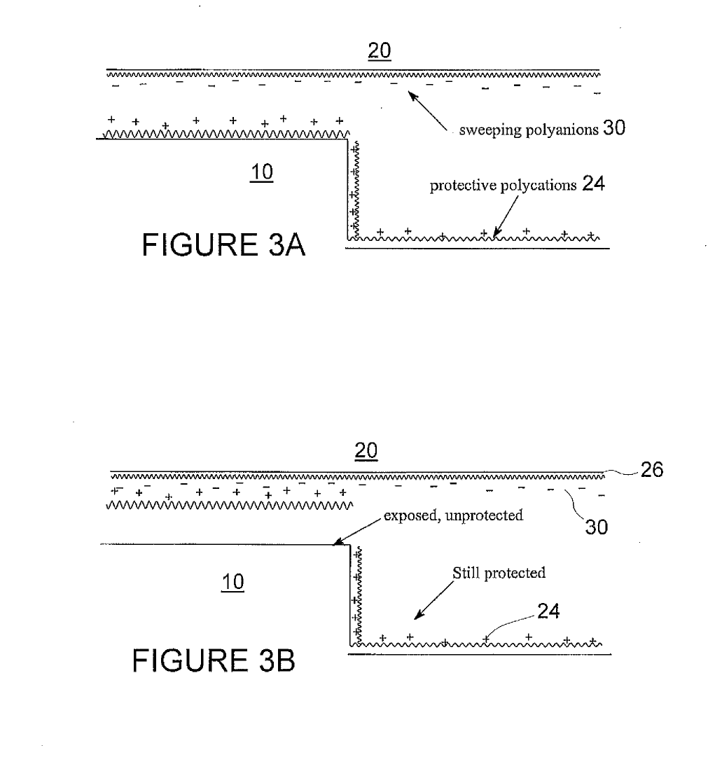

As shown in FIG. 1, a chemical mechanical polishing (CMP) process, a rotating wafer holder brings the wafer or substrate 10 to be polished into contact with a polishing pad 20. The CMP pad 20 is mounted on a rotating platen 22. The details of platen 22 are known to those in the art and the platen 22 is shown herein schematically. A polishing medium 24, such as an abrasive slurry, is supplied between the wafer 10 and the pad 20. An abrasive slurry for metal CMP generally contains an oxidizer, abrasive particles, a complexing agent, and a passivating agent, as known in the art. For a so called abrasive free system, the abrasive particles are removed from the slurry. In a supramolecular abrasive-free design, an activator for the oxidizer may be kept separately from the oxidizer and allowed to contact the oxidizer directly only during the polishing. The oxidizer or the activator can be caged in a supramolecular structure such as micelles or vesicles.

The polishing medium 24 can have a variety of known constituents. By way of example only and not to be limiting, known or proposed oxidizers for the polishing medium 24 include hydrogen peroxide, potassium iodate, potassium permanganate, ammonia, other amine compounds, ammonium compounds, nitrate compounds, and combinations thereof. Exemplary ammonium compounds include, without limitation, ammonium persulfate and ammonium molybdate. Exemplary nitrate compounds include, but are not limited to, ferric nitrate, nitric acid, and potassium nitrate. Some have proposed the use of (NH₄)₂S₂O₈, K₂S₂O₈, or K₃Fe(CN)₈ as acceptable oxidizers. Other proposed or known oxidizers can be utilized.

Similarly, representative non-limiting examples of abrasive particles for abrasive CMP slurries that can be used in the slurries include particulate cerium oxide, particulate alumina, particulate silica and the like. Additionally other abrasives can be used.

Illustrative non-limiting examples of complexing agents for polishing medium 24 include complexing agents acids or salts of: citric, iminodiacetic, 2-aminoethyl phosphonic acid, aminotri-(methylenephosphonic acid) 1-hydroxyethylidene-1,1-phosphonic acid and diethylenetri-aminepenta-(methylenephosphonic acid), and glycine. The complexing agents that are known can be soluble or insoluble. Proposed or known insoluble complexing agents include benzotriazole, 6-dioxaspirol [4,4]nonane 2,7-dione, dioximes, and combinations thereof. Further, known or proposed soluble complexing agents include 2,4-pentanedione dioxime, citric acid, copper-complexing catechol derivatives, copper-complexing alpha organic acids, copper-complexing hydroxamic acids, copper-complexing amino acids, copper-complexing dicarboxylic acids, and combination thereof. Other complexing agents are known and may be used.

Representative non-limiting examples of passivating agents (i.e., corrosion inhibitors) for CMP polishing medium 24 include the best-known and most widely used inhibitors for copper of tolyltriazole (TTA), mercaptobenzothiazole and benzotriazole (BTA) and their derivatives known as azole derivatives. Other proposed or known passivating agents may also be used. Example of commercial slurries for use in the polishing of semiconductor substrates include but are not limited to Copper Ready™ brand available from Dupont and iCUe ep-c600y available from Cabot Microelectronics Materials Division, Aurora, Ill. As described below the present invention allows for a customization of slurries to take advantage of the functionality added to the pad in the present invention. For example a pad functionalized with complexing agent could use a slurry with no or reduced complexing agent. In general in the present invention, the polishing medium 24 will comprise conventional materials but may omit certain constituents relative to the functional group added to the pad, or may have constituents to complement the functional group in the pad.

In the present invention, a functional group 30, such as an activator, can be embedded in to a polishing layer 26 of the CMP pad 20 through chemical bonding thereto, as shown schematically in FIG. 2. The covalent bonding of the functional group 30 to the polishing layer 26 of the pad 20 allows the functional group to be maintained with the pad 20 for pad re-use. An ionic bonding of the functional group 30, discussed below, to the polishing layer 26 allows the pad 20 to act as a dispenser of the functional group 30, but this requires a loading of the pad 20 before each use (and requires an inclusion of a constituent in the polishing layer for the functional group to form an ionic bond with). The CMP pad 10 shown in FIG. 2 includes porous polishing layer 26, that can be formed of polyurethane as known in the art, and a backing or sub-layer 28 also generally known in the art. The CMP pad 10 may also be a single layer structure, or multi-layer structure as known in the art. The present invention addresses the inclusion of a functional group 30 to the polishing layer 26 of the CMP pad 20, and the remaining structure of the CMP pad 30 may be in many configurations known in the art.

In a non limiting embodiment of the present invention the functional group is derived from a compound comprising a polyamine, a polyelectrolyte, and/or an amino acid.

Polyamine within the scope of the present application include diamines, triamines and higher. Suitable diamines include, but are not limited to, aliphatic diamines such as alkylene diamine which may be linear or branched having 2-3 carbons in the alkaline group, including ethylene diamine. Suitable diamines include, but are not limited to, aromatic diamines. The polyamine may also be a copper complexing agent, such as listed above.

Polyelectrolytes suitable for the present invention include, but are not limited to, polyacrylic acid, polymethacrylic acid, polymethyl methacrylic acid, polymaleic acid, polyvinyl sulfonic acid, polyacrylic acid-co-maleic acid, polyvinyl amine, polyethylenimine, poly4-vinyl pyridine, polyamino acids, poly acrylamide, polyacrylamide-polyacrylic acid co-polymers, salts thereof, and esters thereof, and combinations thereof. Further, amino acids include, but are not limited to, glycine, picolinic acid, tyrosine, histidine, methylalanine.

The present invention allows for a functional group 30 in the pad 20 that could not be supplied in the polishing medium 24 or slurry, e.g. continuants that would make the slurry unstable. This effectively increases the components that may be used as effective functional groups 30. The added functionality of the functional group 30 may be distributed throughout the CMP pad 20. However, as the MRR and selectivity are functions of patterns and groove configurations of the polishing layer, the added function groups 30 may be incorporated into the polishing layer 26 of the CMP pad 20 at selected topography provided that the conditioning process would not change such distribution profile. The added functionality provided by the selected functional group 30 may have an impact on the wetting of the CMP pad, expressed by its characteristic contact angle when it is in contact with working polishing media 24, namely the functionality may be designed to enhance these wetting properties.

Although various combinations can be found between activating-functional groups and oxidizers to be activated, the following designs and examples are some of the preferred embodiments. Those who are skilled in the art may extend the applications of these embodiments without departing from the spirit and scope of the invention in its broadest form.

One non-limiting embodiment of the present invention gives the CMP pads 20 an activating functionality through the functional group bonded to the polishing layer 26 through covalent or ionic bonds. Another non-limiting embodiment of the present invention gives the CMP pads 20 an activating functionality through the functional group bonded to the polishing layer 26 through covalent bonding and said covalently bonded functionality is further functionalized by activating groups through ionic or covalent bonds. An abrasive free polishing medium 24, also called a polishing solution, may be introduced onto the polishing layer 26 and between the pad 20 and metal surface of the substrate 10. In the polishing media 24, a passivating agent is included to protect the lower lying area on the metal surface of the substrate 10. The passivating agent of the polishing media 24 will also cover the higher areas but it will be easily removed by the polishing layer 24 of the pad 20. Upon contact, the fresh metal surface is exposed to the polishing layer 26 and the oxidizer in the polishing media 24. The interaction between the functional group 30 on the polishing layer 24 and the oxidizer in the polishing media 24 yields an even strong oxidizer. The stronger oxidizer accelerates the removal of the metal of the substrate 10 at higher laying areas, as shown in FIG. 1. More specifically, in reference to FIG. 2, an activator group forming the functional group 30 may be built into the polishing layer 26 of the CMP pad 20 covalently throughout the polishing layer 24 structure. The polishing media 24 may be an oxidizer solution that flows through the polishing layer 24 of the CMP pad 20 during polishing. When the activator group forming the functional group 30 in the polishing layer 26 of the CMP pad 20 and the oxidizer molecules in polishing media 24 are in direct contact, they react to yield a stronger oxidizer and correspondingly higher removal rate.

Without being limited thereto, the functional group 30 could be derived from a polyamine, such as a diamine derivative. It is known that a diamine compound can accelerate the decomposition of a persulfate, often found in polishing media 24, which leads to the formation of a stronger oxidant. The stronger oxidants can cause polymerization, which operation is known in dental practice. Further, in CMP processes, the oxidant can enhance the removal rate of certain metal surfaces, such as copper. The combination of APS and EDA gives a significant MRR enhancement for copper CMP. The following is a proposed reaction mechanism for the activation of persulfate using a diamine compound:

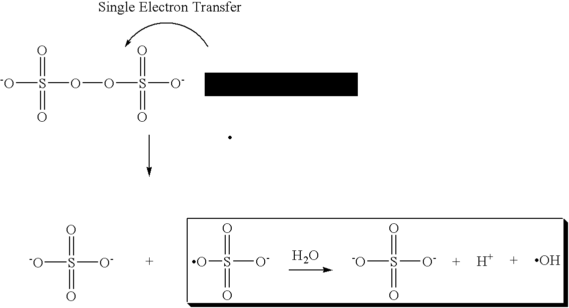

Another illustrative non-limiting example of the activating CMP pad 20 according to the invention is that the functional group 30 is selected from a compound that can form a complex with copper ions which, in turn, can react with hydrogen peroxide to yield an even stronger oxidant, hydroxyl radical. Such a stronger oxidizer can accelerate the removal of metal surfaces in the substrate 10. In an embodiment of this example the functional group is derived from an amino acid. Suitable examples of which are discussed above.

In another non-limiting embodiment of the present invention the selected functional group 30 gives the CMP pad 20 a functionality that can prevent step height from developing by selectively removing the passivating layer of the polishing medium 24 in the high area of the substrate 10 while keeping the passivating layer or film untouched in lower areas of the substrate 10. One such example is to use a polyelectrolyte, such as polyethyleneimine (PEI), in the polishing medium 24 to coat the metal surface of the substrate 10 to be polished. The polyelectrolyte can be delivered through an abrasive free polishing medium 24. The pad 20 may then be constructed with polyelectrolyte with negative charge as the functional group 30. Upon contact, the strong interaction between electrolytes should yield a removal of the protective layer and exposure of the upper layer of the substrate 10. The exposed upper area will thus experience a higher removal rate. This approach can be easily adapted to copper CMP and is schematically illustrated in FIGS. 6a and b. Further, the pad 20 can be impregnated with positively charged polyelectrolyte forming the functional group 30. The electrolyte in the polishing medium 24 used to protect the metal surface of the substrate 10 to be polished can thus be negatively charged. One obvious advantageous application of this design is noble metal CMP. In such a noble metal CMP, the metal to be polished can be passivated with negatively charged polyelectrolyte, such as polyacrylate. The removal of such passivating layer will expose the fresh metal surface to oxidizers and result in a higher removal rate at the higher areas of the substrate.

The following are representative non-limiting examples of the process of making the CMP pad 20 according to the present invention. The surface treatment of a polishing layer 26 of an existing manufactured CMP pad is only one of the many possible schemes to introduce extra functionality of the functional group 30 into the final pad 20. A further manner of constructing the CMP pads 20 according to the present invention is to functionalize the polymers before they are cast into pads 20. In other words, covalently incorporate the functional group 30 into the polishing layer 24 of the pad 20 at the time of original manufacture of the pad 20. In the following examples, the pad 20 was 8″ in size. Although it may present a greater challenge to modify pads larger than 8″ using the same procedure, nothing in this disclosure is limited to the size of the pads 20. In should be apparent to those of ordinary skill in the art that with the functional group 30 covalently bonded to the pad 20 the functionality of the group 30 with the polishing medium 24 is provided topographically (e.g. only at the high spots where the polishing pad 20, wafer 10 and slurry, and not at the low areas), which is distinguished from the isotropic properties (operates at high and low areas of the wafer 10) from similarly soluble functional groups provided in the polishing medium 24. A further feature of this construction is that it allows for functionality at selected areas through a functional group that can not be supplied in the polishing media (e.g. it makes the polishing media unstable). For example, polyethylineimine or derivatives thereof may cause abrasive flocculation in conventional slurries when stored over time, but can be added as a functional group to the pad 20 without disrupting the slurry as it is not stored with the slurry. A further feature of the pad 20 of the invention allows certain functional groups to be used that when dissolved in a prior art slurry have been known to leave an unacceptable stain or the like on the wafer. This property of the invention is because the functional group 30 is bonded to the pad 20 (i.e. it stays with the pad 20 when the pad 20 is disengaged from the wafer 10 at the end of the polishing and not on the wafer 10).

### Example 1

The modification of a manufactured pad can be divided into two steps, with example 1 being the first step thereof. The first step is to introduce ClCO group onto the polishing surface 24 using oxalyl chloride:

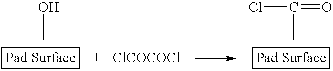

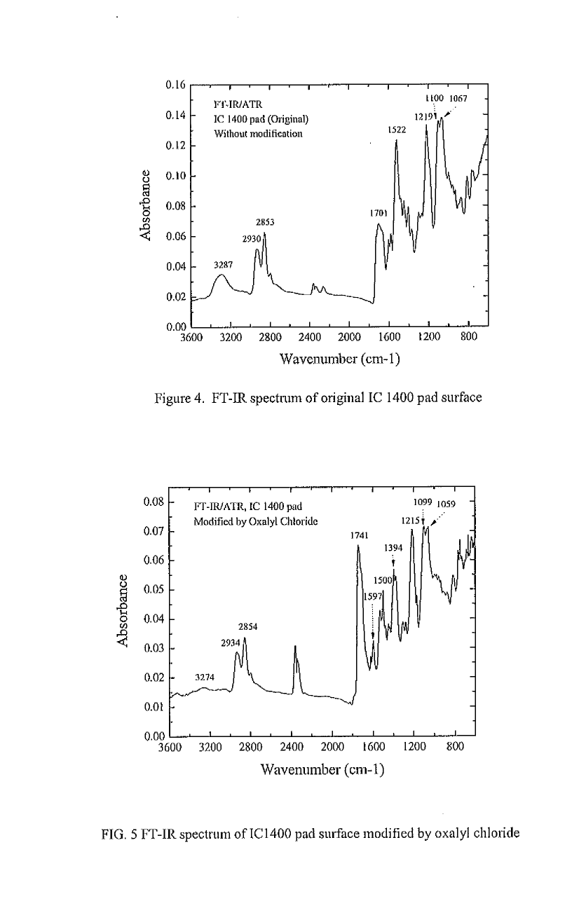

An existing CMP pad, namely a commercially available IC1400™ brand CMP pad from Rodel, Inc. (hereinafter the IC 1400 pad), was first immersed into 1.0M oxalyl chloride solution in ethyl acetate at room temperature for about 60 min. The pad was then washed by ethyl acetate, ethanol, water and then acetone. The modified pad was characterized with FT-IR/ATR after it was dried in vacuum overnight about 30° C. FIG. 4 shows an IR spectrum of the original IC 1400 polishing layer 24 surface. FIG. 5 shows an IR spectrum of the IC1400 polishing layer 24 surface modified by oxalyl chloride. Comparing with the original pad (FIG. 4), (i) A band at 3287 cm-1 (assigned to OH group) disappeared after modification; (ii) A strong band at 1741 cm-1 (assigned to C═O group) appeared after modification. It is therefore concluded that the Cl—C═O group has been successfully introduced onto the polishing layer 24 surface.

### Example 2

This is the second stage of forming a pad 20 according to the present invention. In this example, the pad was modified using a procedure described in example 1 and is further functionalized in order to introduce NHCH₂CH₂NH₂ group onto pad surface using ethylene diamine (EDA):

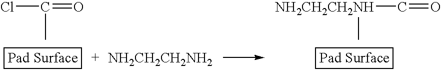

The pad from Example 1 was immersed into 1.0 M EDA in ethyl acetate at room temperature for about 45 min. The pad was washed by ethyl acetate, ethanol, water and then acetone. The modified pad 20 was characterized with FT-IR/ATR after it was dried in vacuum overnight about 30° C. FIG. 6 shows an IR spectrum of the IC1400 pad modified by EDA. Comparing to FIG. 4, (i) A band at 3291 cm-1 appeared (assigned to NH group); and (ii) The C═O band at 1741 cm-1 shifted to 1651 cm-1. It is thus concluded that the polishing layer 24 of the pad 20 was successfully modified with —NHCH₂CH₂NH₂ group.

### Example 3

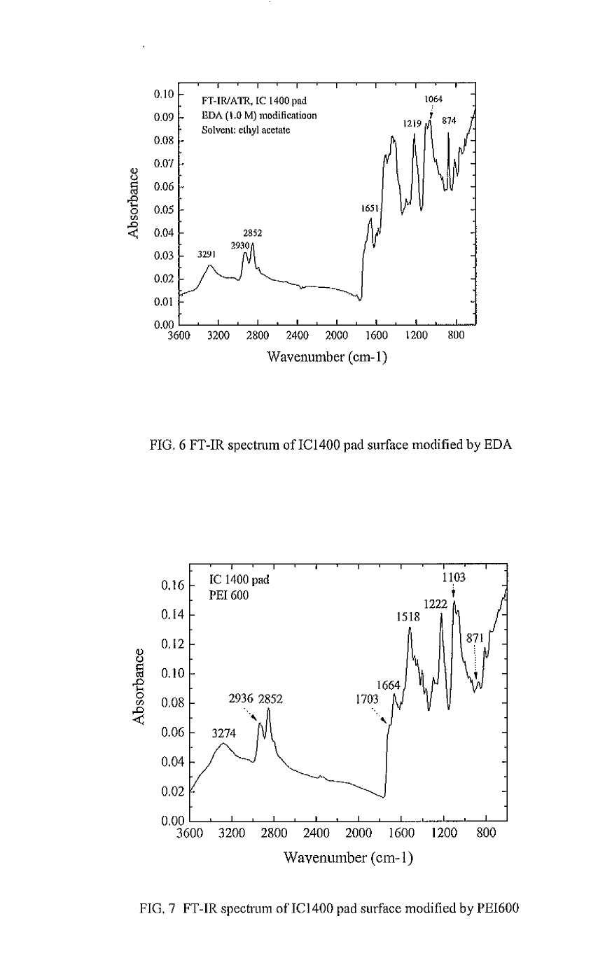

This is the second stage of forming a pad 20 according to the present invention. In this example, the pad which was modified using a procedure described in Example 1 is further functionalized in order to introduce a polymer that contains NH₂ group. More specifically, polyethylenimine (PE1600) was used to modify the surface. The pad from Example 1 was immersed into 10.0% PEI 600 in isopropanol at room temperature for about 75 min. The pad was washed by ethanol, water and then acetone. The modified pad was dried in vacuum for overnight at about 30° C. before IR measurement. FIG. 7 shows an IR spectrum of the pad 20, i.e. the IC1400 pad modified by PE1600. After PE1600 modification, (i) A band at 3274 cm-1 appeared (assigned to NH group); and (ii) The C═O band at 1741 cm-1 shifted to 1664 cm-1. It is this concluded that the polishing layer 24 of the pad 20 was successfully modified with PE1600.

### Example 4

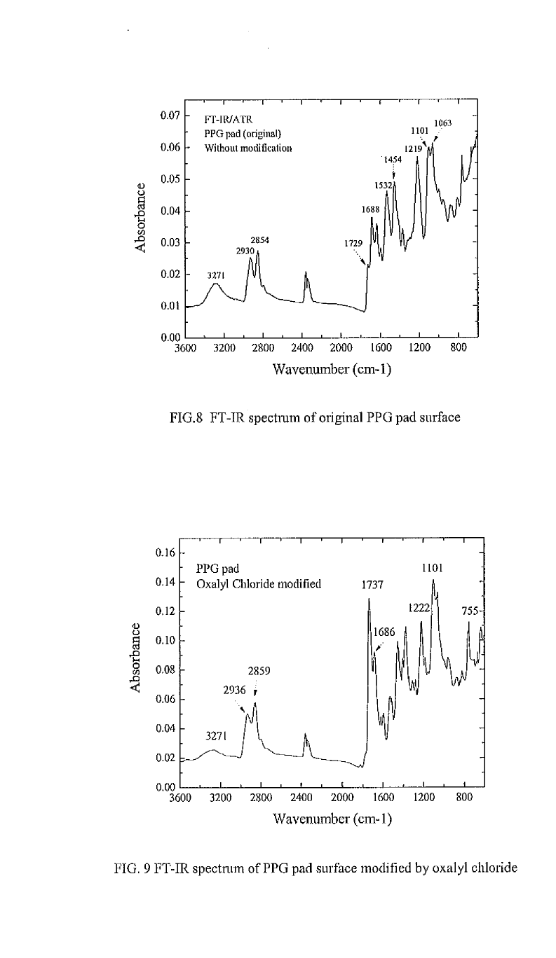

The modification of an existing manufactured CMP pad can be divided into two steps, with example 4 being the first step thereof. In this example, an existing CMP pad, namely a commercially Fast Pad™ brand CMP pad from PPG Industries, Inc. (hereinafter the PPG pad), was modified with oxalyl chloride using a procedure similar to that described in Example 1. The PPG pad was first immersed into 1.0 M oxalyl chloride in ethyl acetate at room temperature for about 60 min. The pad was washed by ethyl acetate, ethanol, water and then acetone. The modified pad was characterized with FT-IR/ATR after it was dried in vacuum overnight at about 30° C. FIG. 8 shows an IR spectrum of the original PPG pad polishing layer surface. FIG. 9 shows an IR spectrum of the PPG pad polishing layer surface modified by oxalyl chloride. Comparing to the original PPG pad, (i) A strong band at 1737 cm⁻¹ (assigned to C═O group) appeared; and (ii) The OH band at 3271 cm⁻¹ almost disappeared. It is thus concluded that the Cl—C═O group was successfully introduced on to the polishing layer pad surface.

### Example 5

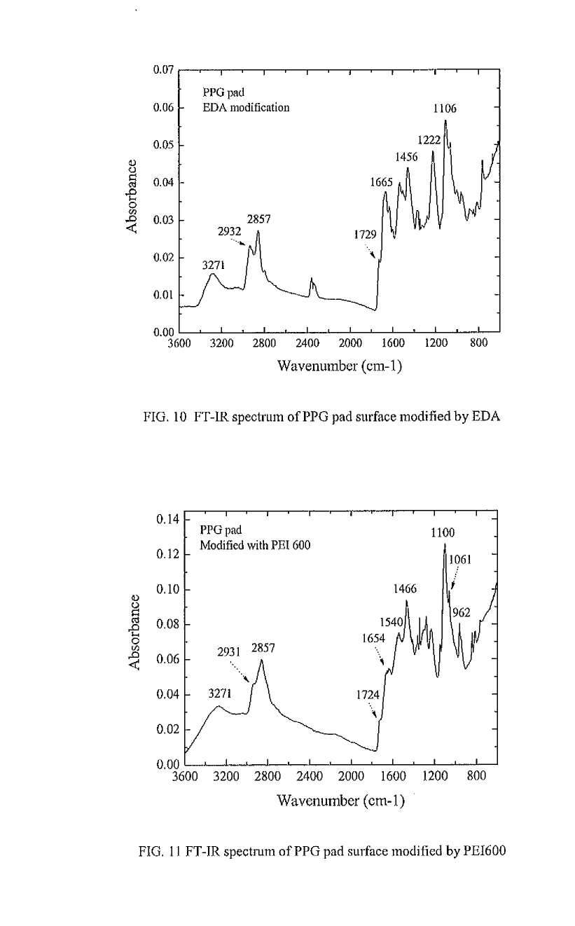

In this example, the PPG pad that was modified using a procedure described in Example 4 is further functionalized to introduce an amino functional group 30. The modified PPG pad was immersed into 0.5 M EDA in ethyl acetate at room temperature for about 45 min. The pad was washed by ethyl acetate, ethanol, water and then acetone. The modified pad was characterized with FT-IR/ATR after it was dried in vacuum overnight at about 30° C. FIG. 10 shows an IR spectrum of the PPG pad modified by EDA. After EDA modification, (i) A band at 3271 cm⁻¹ appeared stronger; and (ii) The C═O band at 1737 cm-1 shifted to 1665 cm-1. It is thus concluded that the pad surface was successfully modified with —NHCH₂CH₂NH₂ group.

### Example 6

In this example, the PPG pad which was modified using a procedure described in Example 4 is further modified with a polymer (PE1600) in order to introduce an amino functional group 30. The modified PPG pad was immersed into 10.0% PEI 600 in isopropanol at room temperature for about 60 min. The pad was washed with ethanol, water and then acetone. The modified pad was dried in vacuum for overnight at about 30° C. before IR measurement. FIG. 11 shows an IR spectrum of PPG pad modified by PE1600. After PE1600 modification, (i) A band at 3271 cm-1 appeared (assigned to NH group); and (ii) The C═O band at 1737 cm-1 caused by oxalyl chloride shifted to 1654 cm-1. It is thus concluded that the PPG pad surface was successfully modified with PE1600.

### Test 1

In this test, a set of polishing experiments were conducted on original CMP pads (the IC 400 pad) and modified pads (pad 20 described in example 2) to confirm the introduction of reactive functional groups 30 on to the pad surface, specifically on the polishing layer 26.

An aqueous solution containing oxidizer was prepared by simply adding all key ingredients including persulfate into a vessel fitted with a magnetic stirring system. To the container, deionized water was also added during stirring. The pH of the solution was then adjusted using dilute KOH or HCl to achieve desired pH.

A copper disk with 1″ diameter was attached to a stainless-steel carrier and then mounted on a single side polishing machine (Struers Labopol-5 Grinding Table and Struers LaboForce Arm, Westlake, Ohio). A polyurethane IC1400 polishing pad was used for the study. A typical polishing lasts 3-5 minutes under a pressure of 6 psi by supplying the slurry at 60 mL/minute between the wafer and the pad. The wafer and the pad have a relative rotating speed of 150 rpm. After polishing and cleaning, the material removal rate was calculated based on net weight loss and polished surface area.

The comparison between modified and original pads for copper material removal rate (MRR) is shown in Table 1. For Samples 1# and 4#, both original and modified pads gave minimal MRR (5.2 and 9.1 nm/min) when only DI water was supplied to the polisher. This is consistent with the fact the chemical modification did not alter the physical structure of the pad significantly. For Sample 2# (MRR=79.0 nm/min), the oxidizer alone with an unmodified pad yielded a significant rise in MRR. As expected, the combination of oxidizer and activator in solution gave even higher MRR due to the interaction between the oxidizer and activator. For Sample 5# (MRR=255.5 nm/nm), using modified pad that contains the activator on the surface and a solution that supplies the oxidizer, a removal rate that is comparable to sample #3 (MRR=240.9 nm/nm) was obtained without the use of free-dissolving activator. This is a direct confirmation of the success of surface functionalization of the pad.

TABLE 1

| | | KPS | EDA | | MRR |
|---|---|---|---|---|---|
| Sample | IC1400 pad | (%) | (%) | pH | (nm/min) |
| 1# | Original | 0 | 0 | 8.0 | 5.2 |
| 2# | Original | 0.2 | 0 | 8.0 | 79.0 |
| 3# | Original | 0.2 | 0.2 | 8.0 | 240.9 |
| 4# | Modified by | 0 | 0 | 8.0 | 9.1 |
| | EDA | | | | |
| 5# | Modified by | 0.2 | 0 | 8.0 | 255.5 |
| | EDA | | | | |

### Test 2

In this test, a set of polishing experiments were conducted to test the lifetime of the newly introduced functional groups 30 on the pad 20. The experimental results are shown in Table 2 for the PEI-modified IC 1400 pad (example 3). The removal rates (MRR) were high for the first two runs (˜375 nm/min). This may be the result of some free PEI residue. After that (Run 3 to Run 8), MRR is almost constant at about 250 nm/min, which is much higher than the control experiment using unmodified pad (MRR=79.0 nm/min). This demonstrated that the pad 20, modified with PEI 600, kept the functional groups 30 active on the pad 20. It is anticipated that this pad 20 can be re-used for more than 32 times without loosing the active groups on surface.

TABLE 2
The lifetime of PEI-modified IC1400 pad for polishing
Cu disk (KPS = 0.2% wt, pH = 8.0)

| | Run | | | | | | | |
|---|---|---|---|---|---|---|---|---|
| | 1# | 2# | 3# | 4# | 5# | 6# | 7# | 8# |
| MRR | 378.2 | 371.2 | 280.3 | 257.6 | 261.6 | 301.5 | 246.9 | 242.9 |
| (nm/min) | | | | | | | | |

### Test 3

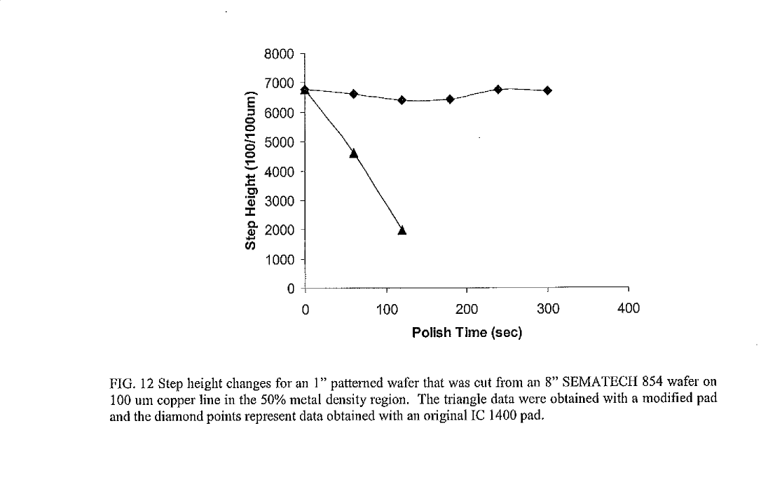

In this test, the ability of a pad 20 according to the present invention to planarize topography is demonstrated. More specifically, the step height reduction efficiency of a standard testing patterned wafer on original pads and modified pads 20 of the present invention was measured. As shown in FIG. 12 the step height of 100 um copper line on a 1″ patterned wafer in the 50% metal density region remains essentially the same throughout the polish when a original pad (an IC 1400 pad) was used in combination with a solution of a persulfate oxidizer and DEA as the activator. However, when a surface treated pad 20 according to the present invention (Example 2) was employed during the polish, the step height for the copper line in the same region on a patterned wafer reduced significantly. It is thus concluded that surface modification of the pad 20 can have the needed step height reduction efficiency for patterned wafers.

In summary, an extra functional group 30 can be introduced to a polishing pad 20 which allows the pad 20 to chemically interact with a component in the slurry or polishing medium 24. The chemical interaction causes greater material removal from the metal film of the substrate to be polished according to the topographically location, in other words an enhanced step height reduction efficiency. The polishing medium 24 may be an abrasive free system. The functionality of the functional group 30 may be a catalyst or activator for an oxidizer in the slurry as described above. The catalyst or activator may be an amine or an amine complexed with a metal ion. The oxidizer may be a peroxide or persulfate with various counter ions. The functionality of the functional group 30 may be a group of polyions that cause the static charge difference between the pad 20 and the metal film of the substrate 10 to be polished as described above. The said functional group 30 may be a low molecular weight amines such as ethylene diamine, alkyl amines, aryl amines, amino alcohols, etc. The functional group 30 may constitute 1-10% of the total pad surface chemical bonds. The functionality of the functional group 30 may be a group of polyions working with a set of polymers found in the slurry.

The functional group 30 may be introduced to a pre-manufactured pad. The procedure for the introduction of functional groups 20 may include the incorporation of a ClCO group onto polishing layer 24 using oxalyl chloride. The modified pad is then modified with amines such as ethylene diamine (EDA) or polyethylenimine. The functional group 30 may be introduced to the polymeric materials before the formation of the pad. The functional groups may be covalently linked to the base polymer in the polishing layer 26. Alternatively the functional group may be ionicly bonded to a group in the polishing layer as described below.

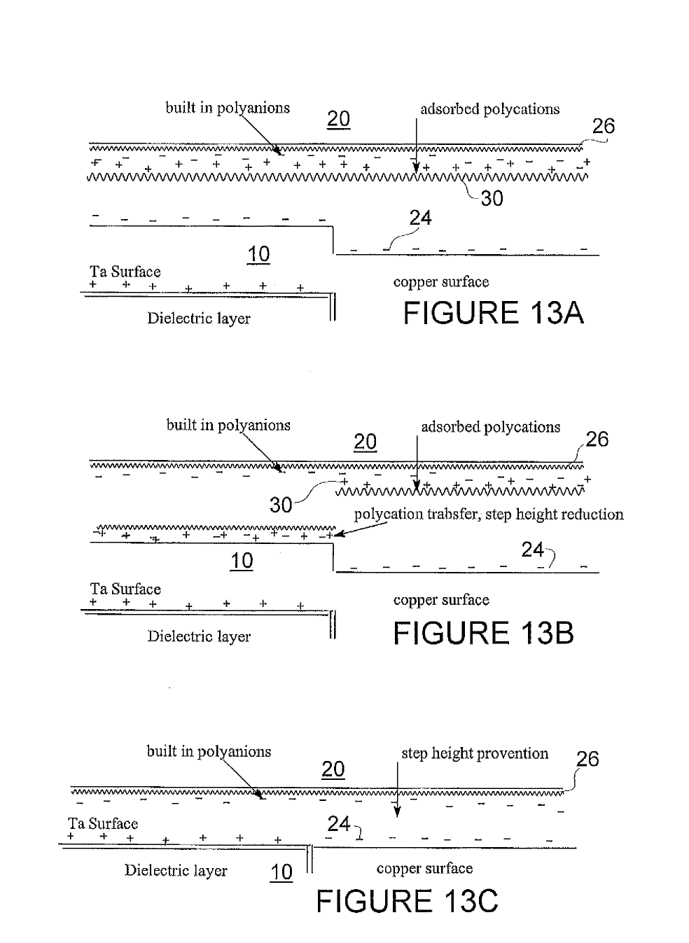

One non-limiting embodiment of the invention provides a self regulating pad 20. In this approach, the pad 20 serves as a controlled release device. Depending upon the processing parameters, the pad 20 is pre-loaded with fixed amount of activating agent forming the functional group 30, which activating group is ionically bonded to the functionalized polishing layer 24. The polishing layer 24 will have an embedded component to bond with the functional group 30, such as the built in polyanions shown in FIGS. 13a-c. During the polishing, the pad 20 will supply activating agent in the form of the functional group 30 to the metal surface of the substrate to be polished. Furthermore, the pad 20 will only allow the high area of a desired metal surface to receive such chemicals, as generally shown in FIGS. 13a-c and described above. After the clearing of the desired metal surface, the pad 20 effectively shuts off its delivery of activating ingredient of the functional group 30 as only a predetermined fixed amount was provided. In an example illustrated in FIGS. 13a-c, the same charge between copper and the pad should serve as a built-in end point detection to protect the copper line from further dishing. Similarly, the same charge between pad and the oxide dielectric layer can also reduce the development of erosion.

Although the strategy shown in FIGS. 13a-c is illustrated with polyelectrolyte and charge scheme, alternative encapsulation and release scheme could include micelle, microemulsion droplet, polymer pocket, and other supramolecular structures. These schemes can certainly be utilized to provide an intelligent controlled release system for a self-stopping CMP. A pad 20 as described in this non-limiting embodiment in which the functional group is added in the form of micelle, vesicle, micro-droplet, encapsulation. This design can include vesicles, micro-encapsulation vehicles, etc. For example, a solid or liquid functional component encapsulated in a polymer shell to form a powder or micro-bead system is then added to the pad during its preparation.

Whereas particular embodiments of this invention have been described above for purposes of illustration, it will be evident to those skilled in the art that numerous variations of the details of the present invention may be made without departing from the invention as defined in the appended claims. The scope of the present invention is intended to be defined by the appended claims and equivalents thereto.

What is claimed is:

1. A chemical mechanical polishing pad and slurry for polishing a surface of a substrate to remove selected portions thereof, the pad and slurry comprising:
A) A polishing slurry configured to contact at least a portion of the pad and to contact at least a portion of the surface of the substrate during polishing;
B) A polishing layer of the pad configured to contact the surface of a substrate in the presence of the polishing slurry to remove selected portions thereof, wherein the polishing layer of the pad is substantially free of abrasive particles; and
C) A functional group chemically bonded to the polishing layer of the pad wherein the functional group acts as an activator or catalyst for a compound in the polishing slurry to exhibit a higher material removal rate for removing selected portions of the surface of the substrate than exhibited in chemical mechanical polishing of a substantially identical substrate in the presence of a substantially identical polishing slurry and a polishing pad wherein the substantially identical polishing layer does not have the functional group.

2. The chemical mechanical polishing pad and slurry of claim 1 wherein the functional group is derived from a compound comprising a polyamine, a polyelectrolyte, and/or an amino acid.

3. The chemical mechanical polishing pad and slurry of claim 1 wherein the polishing layer comprises a porous polyurethane, wherein the functional group is derived from ethylene diamine, and wherein the polishing slurry includes potassium persulfate.

4. The chemical mechanical polishing pad and slurry of claim 1 wherein the polishing layer comprises a porous polyurethane, and wherein the functional group is derived from polyethyleneimine.

5. The chemical mechanical polishing pad and slurry of claim 1 wherein the polishing layer comprises a porous polyurethane, and wherein the functional group is derived from an amino acid.

6. The chemical mechanical polishing pad and slurry of claim 1 wherein the polishing layer comprises a porous polyurethane, and wherein the slurry includes a polyacrylate.
